(19) United States
(12) Patent Application Publication
(10) Pub. No.: US 2026/0037945 A1
(43) Pub. Date: Feb. 5, 2026

(54) CONTROL METHOD, CONTROL DEVICE, AND RECORDING MEDIUM

(71) Applicant: Panasonic Intellectual Property Management Co., Ltd., Osaka (JP)

(72) Inventors: Takeru KOIE, Saitama (JP); Kakuya YAMAMOTO, Hyogo (JP); Ayaka NAKASAKA, Osaka (JP); Yuji UNAGAMI, Osaka (JP)

(21) Appl. No.: 19/357,791

(22) Filed: Oct. 14, 2025

Related U.S. Application Data
(63) Continuation of application No. PCT/JP2024/015231, filed on Apr. 17, 2024.
(60) Provisional application No. 63/460,704, filed on Apr. 20, 2023.

(51) Int. Cl. G06Q 20/12; G06Q 20/38; G06T 17/00

(52) U.S. Cl. CPC G06Q 20/123; G06Q 20/3825; G06Q 20/3827; G06T 17/00

(57) ABSTRACT

A control method is a control method for a control device, the control method including: obtaining first content information subjected to detail enhancement in a virtual space, the first content information being generated in a first platform that is for performing the detail enhancement on content; listing a first NFT associated with the first content information on a second platform that is for buying and selling the first NFT; and distributing, to a creator who generated the first content information in the first platform, a profit based on a token paid in the second platform.

### CROSS REFERENCE TO RELATED APPLICATIONS

This is a continuation application of PCT International Application No. PCT/JP2024/015231 filed on April 17, 2024, designating the United States of America, which is based on and claims priority of U.S. Provisional Patent Application No. 63/460704 filed on April 20, 2023. The entire disclosures of the above-identified applications, including the specifications, drawings and claims are incorporated herein by reference in their entirety.

### FIELD

The present disclosure relates to a control method, a control device, and a recording medium.

### BACKGROUND

Patent Literature (PTL) 1 discloses a technique for buying and selling non-fungible tokens (NFTs) for proving the authenticity of digital content or the owner of digital content.

### Citation List

### Patent Literature

PTL 1: Japanese Patent No. 7129579

### SUMMARY

### Technical Problem

The present disclosure provides a control method and the like through which profit from the buying and selling of an NFT corresponding to content information can be appropriately distributed to a creator of the content information.

### Solution to Problem

A control method according to one aspect of the present disclosure is a control method performed by a control device, the control method including: obtaining first content information subjected to detail enhancement in a virtual space, the first content information being generated in a first platform that is for performing the detail enhancement on content; listing a first non-fungible token (NFT) associated with the first content information on a second platform that is for buying and selling the first NFT; and distributing, to a creator who generated the first content information in the first platform, a profit based on a token paid in the second platform.

A control device according to one aspect of the present disclosure includes a processor and a memory. Using the memory, the processor: obtains first content information subjected to detail enhancement in a virtual space, the first content information being generated in a first platform that is for performing the detail enhancement on content; lists a first NFT associated with the first content information on a second platform that is for buying and selling the first NFT; and distributes, to a creator who generated the first content information in the first platform, a profit based on a token paid in the second platform.

Note that these comprehensive or specific aspects may be realized by a system, a device, an integrated circuit, a computer program, or a computer-readable recording medium such as a CD-ROM, or may be implemented by any desired combination of systems, devices, integrated circuits, computer programs, and recording media.

### Advantageous Effects

According to the control method and the like of the present disclosure, profit from the buying and selling of an NFT corresponding to content information can be appropriately distributed to a creator of the content information.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an overview of a system according to an embodiment.

FIG. 2 is a block diagram illustrating the configuration of the system according to the embodiment.

FIG. 3 is a block diagram illustrating an example of the configuration of a service server according to the embodiment.

FIG. 4 is a block diagram illustrating an example of the configuration of a management server according to the embodiment.

FIG. 5 is a sequence chart illustrating an example of processing for implementing a detail enhancement service platform according to the embodiment.

FIG. 6 is a sequence chart illustrating an example of processing for implementing an experiential commerce service platform according to the embodiment.

FIG. 7 is a sequence chart illustrating an example of processing for distributing profit according to an embodiment.

FIG. 8 is a sequence chart illustrating an example of processing for registering an NFT corresponding to content information according to the embodiment.

FIG. 9 is an explanatory diagram illustrating the data structure of a blockchain.

FIG. 10 is an explanatory diagram illustrating the data structure of transaction data.

FIG. 11 is an explanatory diagram illustrating transaction data related to the execution of a smart contract.

FIG. 12 is an explanatory diagram illustrating processing related to the execution of a smart contract.

### DESCRIPTION OF EMBODIMENT

### Underlying Knowledge Forming Basis of Present Disclosure

Recently, various types of digital content are being managed in association with NFTs. Using an NFT makes it possible to ensure the authenticity of the digital content and easily identify the owner of the digital content.

When considering the buying and selling of virtual digital content located in a metaverse space, there is no mechanism for distributing profit gained from selling digital content both to the owner of the digital content and the creator who generated the digital content.

The inventors of the present disclosure arrived at a control method and the like through which profit from the buying and selling of an NFT corresponding to content information can be appropriately distributed to a creator of the content information.

A control method according to a first aspect of the present disclosure is a control method performed by a control device, the control method including: obtaining first content information subjected to detail enhancement in a virtual space, the first content information being generated in a first platform that is for performing the detail enhancement on content; listing a first non-fungible token (NFT) associated with the first content information on a second platform that is for buying and selling the first NFT; and distributing, to a creator who generated the first content information in the first platform, a profit based on a token paid in the second platform.

Accordingly, profit from the buying and selling of an NFT corresponding to content information can be appropriately distributed to the creator of the content information. In addition, because the processing in the two platforms is executed by a single control device, communication fees, the amount of data processed, and the amount of data stored can be reduced.

A control method according to a second aspect of the present disclosure is the control method according to the first aspect, wherein the first content information is generated in the first platform based on design information including a shape of a first three-dimensional object in a three-dimensional space, and includes information indicating a color, a texture, and a shape of the first three-dimensional object.

A control method according to a third aspect of the present disclosure is the control method according to the first aspect or the second aspect, wherein the first NFT includes creator information for identifying the creator, and the distributing includes identifying the creator based on the creator information included in the first NFT.

A control method according to a fourth aspect of the present disclosure is the control method according to the second aspect, wherein the first NFT includes NFT information for identifying a second NFT associated with the design information, and the distributing includes further distributing the profit to a designer who generated the design information.

Accordingly, profit from the buying and selling of an NFT corresponding to the content information can be appropriately distributed to the designer who generated the design information.

A control method according to a fifth aspect of the present disclosure is the control method according to the fourth aspect, wherein the second NFT includes designer information for identifying the designer who generated the design information, and the distributing includes identifying the designer based on the designer information included in the second NFT.

A control method according to a sixth aspect of the present disclosure is the control method according to the fourth aspect or the fifth aspect, wherein the first NFT is stored in a first blockchain in the first platform, and the second NFT is stored in a second blockchain in the second platform.

A control method according to a seventh aspect of the present disclosure is the control method according to any one of the first to sixth aspects, wherein content expressed by the first content information is a first three-dimensional object in a three-dimensional space, and a first space occupied by the first three-dimensional object includes a second space occupied by a second three-dimensional object.

A control method according to an eighth aspect of the present disclosure is the control method according to the seventh aspect, wherein the first three-dimensional object is a building, and the second three-dimensional object is an object present within the building.

A control method according to a ninth aspect of the present disclosure is the control method according to any one of the first to sixth aspects, wherein content expressed by the first content information is a first three-dimensional object in a three-dimensional space, and a first space occupied by the first three-dimensional object is included in a second space occupied by a second three-dimensional object.

A control method according to a tenth aspect of the present disclosure is the control method according to the ninth aspect, wherein the second three-dimensional object is a building, and the first three-dimensional object is an object present within the building.

A control method according to an eleventh aspect of the present disclosure is the control method according to any one of the seventh to tenth aspects, wherein the first content information includes first location information indicating a location of the first three-dimensional object in the three-dimensional space, and second content information expressing the second three-dimensional object includes second location information indicating a location of the second three-dimensional object in the three-dimensional space.

A control device according to a twelfth aspect of the present disclosure includes a processor and a memory. Using the memory, the processor: obtains first content information subjected to detail enhancement in a virtual space, the first content information being generated in a first platform that is for performing the detail enhancement on content; lists a first NFT associated with the first content information on a second platform that is for buying and selling the first NFT; and distributes, to a creator who generated the first content information in the first platform, a profit based on a token paid in the second platform.

Accordingly, profit from the buying and selling of an NFT corresponding to content information can be appropriately distributed to the creator of the content information. In addition, because the processing in the two platforms is executed by a single control device, communication fees, the amount of data processed, and the amount of data stored can be reduced.

A recording medium according to a thirteenth aspect of the present disclosure is a non-transitory computer-readable recording medium having recorded thereon a program for causing a computer to execute the control method according to any one of the first to eleventh aspects.

Note that these comprehensive or specific aspects may be realized by a system, a device, an integrated circuit, a computer program, or a computer-readable recording medium such as a CD-ROM, or may be implemented by any desired combination of systems, devices, integrated circuits, computer programs, and recording media.

Embodiments will be described hereinafter with reference to the drawings. Note that the following embodiments describe specific examples of the present disclosure. In other words, the numerical values, shapes, materials, constituent elements, arrangements and connection states of constituent elements, steps, orders of steps, and the like in the following embodiments are merely examples, and are not intended to limit the present disclosure. Additionally, of the constituent elements in the following embodiments, constituent elements not denoted in the independent claims indicating the broadest interpretation are not absolutely necessary for solving the problem of the present disclosure, and will instead be described as constituent elements constituting more preferred forms.

### Embodiment

The present embodiment will describe a control method and the like through which profit from the buying and selling of an NFT corresponding to content information can be appropriately distributed to a creator of the content information.

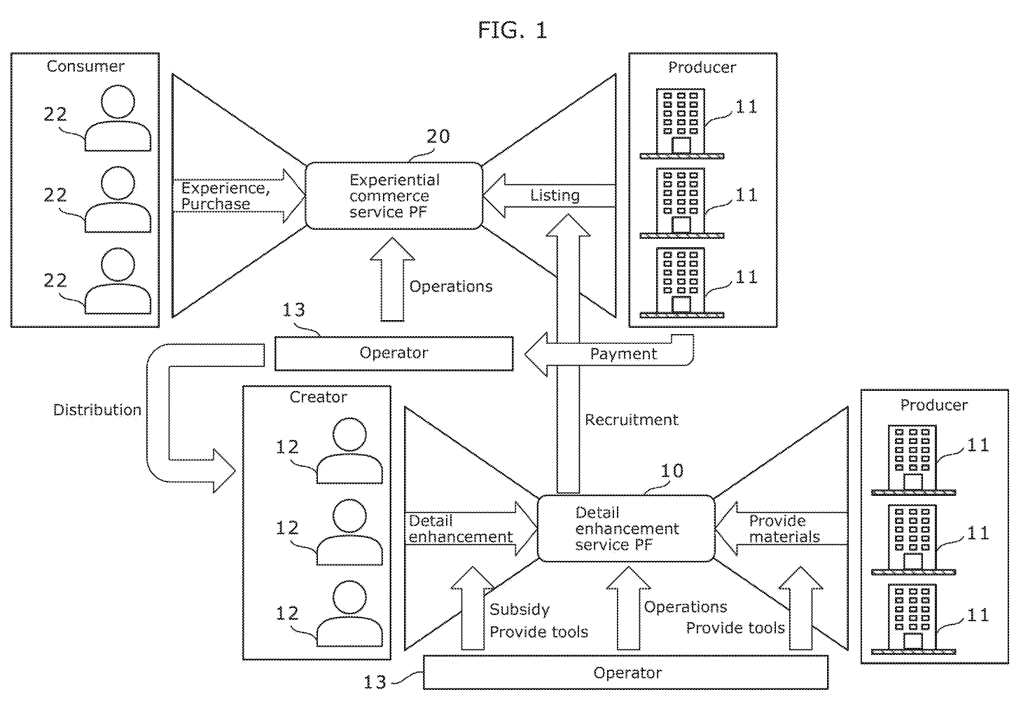

FIG. 1 is a diagram illustrating an overview of a system according to the embodiment.

In FIG. 1, transactions on two platforms are illustrated. The two platforms include detail enhancement service platform 10 and experiential commerce service platform 20. Note that “platform” is denoted as “PF” in the subsequent figures.

Detail enhancement service platform 10 is a platform used to enhance the detail of content expressed by content information. producer 11 provides the resources of the digital data subject to detail enhancement to detail enhancement service platform 10.

Note that the digital data resources may be, for example, the original data of a three-dimensional object before the detail enhancement. The original data of the three-dimensional object may include information expressing a mesh, a texture, a material, or the like. A “mesh” is information that defines the shape of a three-dimensional object, and is a collection of polygons or vertices. The mesh may include information pertaining to vertex coordinates, surface normals, and UV mapping. A “texture” is information that defines the appearance or texture of the surface of a three-dimensional object. Textures are used to reproduce the appearance of various materials such as wood, metal, fabric, skin, or the like. A “material” is information that defines the physical properties or optical behavior of a three-dimensional object. Materials include color, reflectance, transparency, glossiness, and the like. The digital data resources are an example of design information.

Using the digital data resources provided by producer 11, creator 12 makes inputs on a terminal (computer) owned by creator 12 and enhances the detail of the digital data resources. “Detail enhancement” includes processing for increasing the resolution of polygons or vertices that define the shape of a three-dimensional object, processing for increasing the resolution of a texture, processing for assigning textures to vertices that have been increased, processing for increasing the color tone assigned to a texture, and the like. In other words, “detail enhancement” refers to processing that increases the amount of information per unit of volume in a three-dimensional space. A detail-enhanced three-dimensional object has an appearance that better resembles a real object. The detail-enhanced three-dimensional object is stored in detail enhancement service platform 10.

Operator 13 of detail enhancement service platform 10 provides producer 11 with tools for generating digital data resources, provides and creator 12 with tools for enhancing the details of digital data resources, and the like. Operator 13 may provide creator 12 with a subsidy to support the detail enhancement processing by creator 12.

Experiential commerce service platform 20 is a platform for buying and selling NFTs corresponding to content information indicating three-dimensional objects. For example, experiential commerce service platform 20 provides a virtual space (a metaverse). In the metaverse, producer 11 can list detail-enhanced three-dimensional objects generated in detail enhancement service platform 10. Through this, in the metaverse, consumer 22 can experience three-dimensional objects listed by producer 11. For example, in an experience, consumer 22 can view three-dimensional objects, hear sounds related to three-dimensional objects, and the like. Additionally, consumer 22 can purchase an NFT corresponding to a three-dimensional object that has been viewed and heard by experiencing the metaverse, and which has been listed in the metaverse.

Note that consumer 22 is not limited to experiencing three-dimensional objects, and may experience two-dimensional images. The two-dimensional images may be two-dimensional still images or two-dimensional moving images. The two-dimensional images may be images captured by a camera, or may be images generated by a person or a computer. The NFT purchased by consumer 22 may be an NFT corresponding to a two-dimensional image.

When consumer 22 purchases an NFT corresponding to a three-dimensional object, producer 11 pays a fee to operator 13. The fee is a brokerage fee for the establishment of a sales contract between producer 11 and consumer 22 by experiential commerce service platform 20. Operator 13 distributes the fee obtained from producer 11 to creator 12 who generated a three-dimensional object corresponding to the NFT traded in the sales contract. This makes it easy to distribute profit generated by experiential commerce service platform 20 to creator 12 who is not participating in experiential commerce service platform 20.

Note that experiential commerce service platform 20 may be operated by operator 13 operating detail enhancement service platform 10. Alternatively, experiential commerce service platform 20 may be operated by an operator different from operator 13 operating detail enhancement service platform 10.

Note that producer 11 participating in detail enhancement service platform 10 may include the same producer as producer 11 participating in experiential commerce service platform 20. Likewise, producer 11 participating in experiential commerce service platform 20 may include the same producer as producer 11 participating in detail enhancement service platform 10.

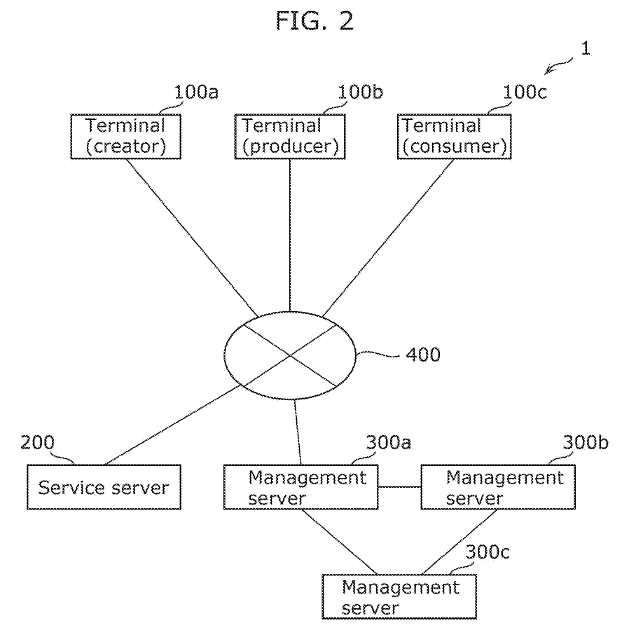

FIG. 2 is a block diagram illustrating the configuration of the system according to the embodiment.

As illustrated in FIG. 2, system 1 includes terminals 100a to 100c, service server 200, and management servers 300a to 300c (also referred to as “management server 300a and the like”). Terminals 100a to 100c, service server 200, and management servers 300a to 300c (also referred to as “management servers 300” and the like) may all be connected to each other over network 400, may all be communicatively connected directly to each other, or some may be communicatively connected over network 400 while others are communicatively connected directly. Network 400 is, for example, the Internet, a cellular telephone carrier network, or the like, but may be constituted by any communication line or network.

Consumer 22 is a user who experiences a virtual space provided by service server 200. Producer 11 and consumer 22 are users who buy and sell three-dimensional objects in the virtual space.

Service server 200 is a server which is a computer that manages the virtual space. Service server 200 generates the virtual space and provides VR data expressing the virtual space by sending the VR data to the user, which contributes to the user’s experience of the virtual space. The virtual space is, for example, a three-dimensional or two-dimensional virtual space. The virtual space can also be generally referred to as the “metaverse”. The VR data includes image data of an image expressing a scene in the virtual space, and may also include audio data expressing audio in the virtual space. Objects and avatars may be present in the virtual space. The avatars may be associated with people in a real space.

Service server 200 uses terminal 100c to enable consumer 22 to experience the virtual space, for example. Service server 200 sends the VR data to terminal 100c and receives information indicating the position and attitude of a VR device included in terminal 100c (also called “location information”). Service server 200 is an example of a control device.

Note that service server 200 is not limited to providing the virtual space in VR, and may provide the virtual space on a web page. In addition, service server 200 is not limited to providing a virtual space, and may use any form as long as users are provided with a place where NFTs can be viewed. Service server 200 may provide a web page on which NFTs can be viewed.

Service server 200 also makes it possible to execute transactions for objects in the virtual space. In a transaction for an object, for example, when the object is transferred from producer 11 to consumer 22, a cryptographic asset (also called “virtual currency”) is transferred from consumer 22 to producer 11. The cryptographic asset is Bitcoin, Ethereum, or the like, for example, and is managed using a distributed ledger. The transfer of the object is managed using the distributed ledger as an example of the transfer of the NFT.

Management server 300a is a server that manages the transfer of cryptographic assets using a distributed ledger. Management server 300a stores the distributed ledger in storage. When transaction data indicating the transfer of a cryptographic asset is received from a VR device or the like, management server 300a executes processing for storing the received transaction data in the distributed ledger. The transaction data indicating the transfer of the cryptographic asset includes an address, in a distributed ledger system, of the source and destination of the transfer of the cryptographic asset.

Management server 300a can also manage the transfer of objects in the virtual space as the transfer of NFTs by using the distributed ledger. When transaction data indicating the transfer of an NFT is received from a VR device or the like, management server 300a executes processing for storing the received transaction data in the distributed ledger. The transaction data indicating the transfer of the NFT includes an address, in a distributed ledger system, of the source and destination of the transfer of the NFT.

When storing new transaction data in the distributed ledger, management server 300a stores the new transaction data in the distributed ledger in a format based on the type of the distributed ledger. Management server 300a can also exchange communication data with the other management servers 300b and 300c, and send the transaction data to the other management servers 300b and 300c to cause the transaction data to be stored in the distributed ledger held by the other management servers 300b and 300c. When storing the transaction data, the transaction data may be stored after first using a consensus algorithm to form a consensus. The transaction data stored in the distributed ledger is managed using properties such as hash values to prevent tampering (described later).

For example, when the distributed ledger is a blockchain, management server 300a generates a block containing the new transaction data and stores the block in the distributed ledger after using a consensus algorithm to form a consensus with management server 300a and the like for the generated block. Note that the format of the distributed ledger is not limited to the foregoing, and other distributed ledger formats (e.g., IOTA, Hashgraph, or the like) can also be used.

Management servers 300b and 300c are management servers similar to management server 300a, and operate independently from management server 300a.

Note that a management server group including management server 300a and the like can also be referred to as a “distributed ledger network”. Although a case where three management servers 300a and the like are included in the distributed ledger network is described as an example, the number of management servers 300a and the like may be four or more.

The VR device is an information processing device that is included in each of terminals 100a to 100c and presents a virtual space to the user who owns each of terminals 100a to 100c, and is an information processing device in the possession of user (producer 11, creator 12, and consumer 22). The VR device includes a Central Processing Unit (CPU), memory, storage, a display screen, a speaker, sensors, and the like, and processes information by the CPU executing predetermined programs using the memory. The VR device may include a Global Positioning System (GPS) receiver that obtains a position of the VR device on Earth. The VR device is worn on the user’s head, for example, and is generally referred to as “VR goggles” or a “VR headset”.

The VR device receives VR data from service server 200, and uses the image data included in the VR data to display an image indicating a scene visible in the virtual space on the display screen to present the scene to the user. The VR device can also present audio data included in the VR data to the user by causing a speaker to output audio heard in the virtual space.

The VR device also obtains location information of the VR device using a sensor (a three-axis accelerometer, a three-axis angular velocity sensor, or the like) and transmits that location information to service server 200. The sent location information is used by service server 200 to generate the VR data, and VR data calculated having taken the sent location information into account is then sent.

The VR device also sends information indicating an operation made by the user on the VR device (also called “operation information”) to service server 200. The operation information can include, for example, an operation to select an action from options for actions that can be performed in the virtual space (what is known as a “selection menu”) or the like. The sent operation information is applied to the location information of the user in the virtual space (i.e., the avatar corresponding to the user), and VR data based on the resulting location information and the like is sent thereafter.

Note that each of terminals 100a to 100c need not include a VR device. Each of terminals 100a to 100c may include one or more display devices capable of displaying a place where NFTs provided by service server 200 can be viewed. The one or more display devices are, for example, liquid crystal displays, an organic electroluminescence (EL) displays, or the like.

Terminal 100a is an information processing terminal in the possession of creator 12, who is the user. Terminal 100a includes a CPU, memory, storage, a display screen, and the like, and processes information by the CPU executing predetermined programs using the memory. Terminal 100a is, for example, a smartphone, a tablet terminal, a personal computer, or the like.

Terminal 100b is an information processing terminal in the possession of producer 11, who is the user. Terminal 100c is an information processing terminal in the possession of consumer 22, who is the user. Terminals 100b and 100c each have the same configuration as terminal 100a.

Note that a device group including service server 200 and management server 300a and the like is a device group involved in NFT transactions in the virtual space, and can also be referred to as an “NFT network”. Note that the NFTs are not limited to what is specified in the Ethereum standard ERC-721, and may be any token that is not replaceable. The “token” may also be any data issued in association with data or a real object.

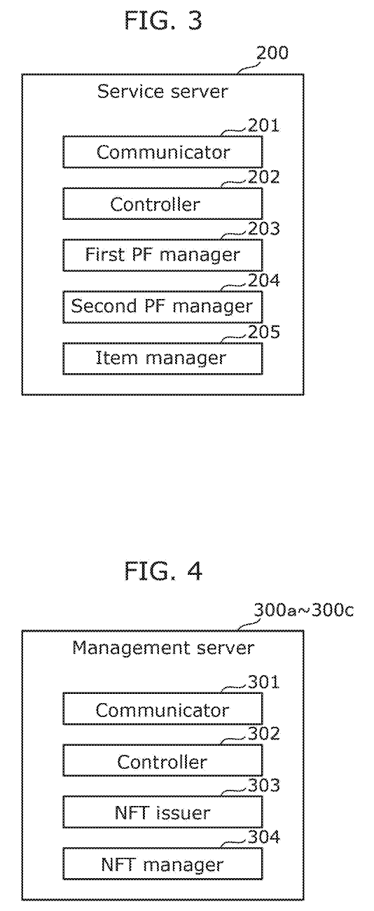

FIG. 3 is a block diagram illustrating an example of the configuration of the service server according to the embodiment.

As illustrated in FIG. 3, service server 200 includes communicator 201, controller 202, first PF manager 203, second PF manager 204, and item manager 205. Communicator 201, controller 202, first PF manager 203, second PF manager 204, and item manager 205 can be realized by a processor (e.g., a Central Processing Unit (CPU)) (not shown) included in service server 200 executing predetermined programs using memory (not shown). Service server 200 is an example of a control device.

Communicator 201 communicates over network 400 with at least one of terminals 100a to 100c and management servers 300a to 300c. Communicator 201 receives information from at least one of terminals 100a to 100c and management servers 300a to 300c. Communicator 201 sends information to at least one of terminals 100a to 100c and management servers 300a to 300c.

Specifically, communicator 201 receives, from terminal 100b of producer 11, design information to be provided to creator 12 on detail enhancement service platform 10. Communicator 201 sends the received design information to terminal 100a of creator 12.

Communicator 201 also receives detail-enhanced content information and a creator ID based on the design information, from terminal 100a of creator 12. The creator ID is identification information for identifying creator 12, and is an example of creator information. Communicator 201 sends the received content information to terminal 100b of producer 11.

Communicator 201 also receives, from terminal 100b of producer 11, content information for listing on experiential commerce service platform 20. Communicator 201 also sends the content information to terminal 100c of consumer 22 in response to a request from terminal 100c of consumer 22. Specifically, communicator 201 sends VR data for providing the metaverse that consumer 22 is experiencing through terminal 100c. The VR data includes the content information.

Communicator 201 also receives, from terminal 100c of consumer 22, an ID of the NFT that consumer 22 purchased in experiential commerce service platform 20, as well as a consumer ID. Communicator 201 receives, from terminal 100b of producer 11, fee information indicating a brokerage fee for the establishment of a sales contract between producer 11 and consumer 22. The sales contract relates to the buying and selling of an NFT on experiential commerce service platform 20.

Additionally, communicator 201 sends a registration request for registering the NFT with management servers 300a to 300c to management servers 300a to 300c. Communicator 201 receives a response to the registration request from management servers 300a to 300c.

Controller 202 executes various types of processing based on the received information. Specifically, controller 202 stores the received information in storage. Controller 202 also executes processing for converting the received content information or the received design information into an NFT. The processing for conversion into an NFT is, for example, processing for causing communicator 201 to send a registration request regarding the NFT to management servers 300a to 300c.

First PF manager 203 manages detail enhancement service platform 10. First PF manager 203 provides detail enhancement service platform 10 to terminal 100a of creator 12 and terminal 100b of producer 11. First PF manager 203 stores the design information, the detail-enhanced content information, and the like.

Second PF manager 204 manages experiential commerce service platform 20. Second PF manager 204 provides experiential commerce service platform 20 to terminal 100b of producer 11 and terminal 100a of consumer 22. Of the detail-enhanced content information, second PF manager 204 stores content information used for the listing by producer 11.

Item manager 205 manages a real item associated with the NFT. In other words, item manager 205 stores an NFT ID for identifying the NFT, and an item ID for identifying a real item in association therewith. Item manager 205 may also store the owner of the item and a location of the item in real space (a storage location), also in association with the item ID.

FIG. 4 is a block diagram illustrating an example of the configuration of the management server according to the embodiment.

As illustrated in FIG. 4, each of management servers 300a to 300c includes communicator 301, controller 302, NFT issuer 303, and NFT manager 304.

Communicator 301 communicates with service server 200 or terminal 100b of producer 11. Communicator 301 receives a registration request for an NFT from service server 200 or terminal 100b. Communicator 301 sends a response to the registration request for the NFT to the device that sent the registration request for the NFT (service server 200 or terminal 100b).

Controller 302 executes various types of processing based on the received information.

NFT issuer 303 issues the NFT in response to the registration request for the NFT.

NFT manager 304 records the issued NFT in the distributed ledger. As a result, a block including the NFT is added to the blockchain.

### Systems Operations

Operations by system 1 having the foregoing configuration will be described next.

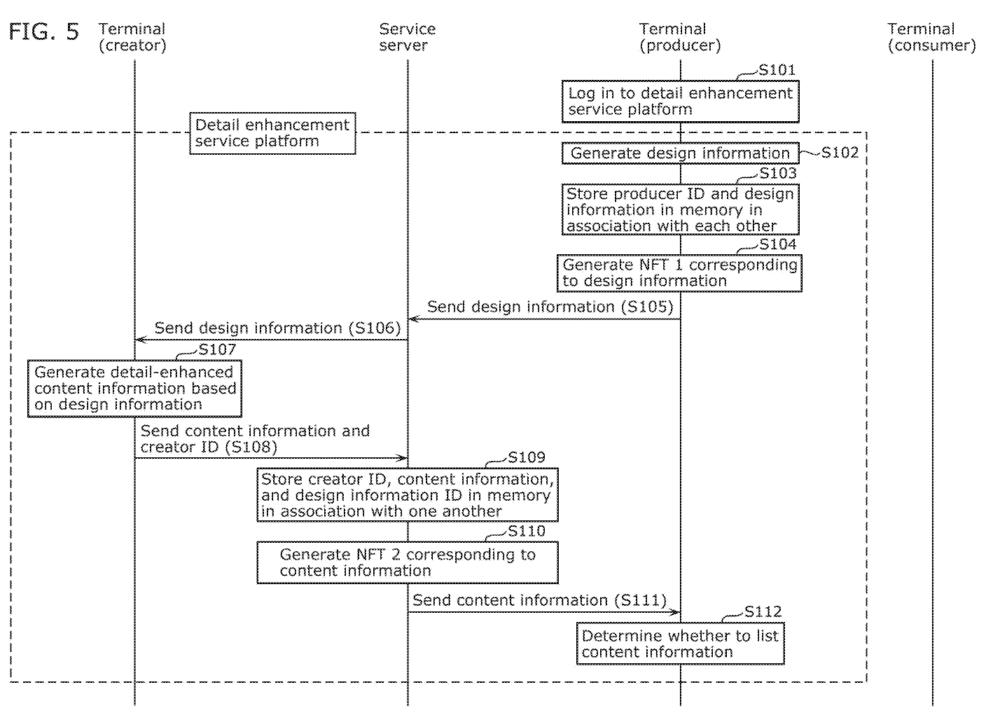

FIG. 5 is a sequence chart illustrating an example of processing for implementing the detail enhancement service platform according to the embodiment.

First, a user serving as producer 11 logs into detail enhancement service platform 10 through terminal 100b (S101). On login, terminal 100b accepts the input of information for logging in to detail enhancement service platform 10 from producer 11 (e.g., a producer ID for identifying producer 11, and a password) and sends that information to service server 200, and then receives information for using detail enhancement service platform 10 from service server 200. Terminal 100b displays a UI based on the information for using detail enhancement service platform 10, accepts an input to the UI from the user serving as producer 11, and changes information to be displayed in response to the received input, stores information generated in response to the input, and the like.

Terminal 100b then generates the design information by accepting an input from the user serving as producer 11 in the UI for implementing detail enhancement service platform 10 (S102).

Terminal 100b stores the producer ID and the design information in the memory included in terminal 100b in association with each other (S103).

Upon the design information being stored in the memory, terminal 100b generates an NFT corresponding to the design information (S104). The NFT corresponding to the design information is an example of a second NFT. This NFT is indicated as “NFT 1” in the figures. The NFT corresponding to the design information may include a producer ID. The producer ID is an example of designer information. Producer 11 is an example of a designer.

Terminal 100b sends the generated design information to service server 200 (S105).

Upon receiving the design information from terminal 100b, service server 200 stores the received design information and sends design information, among the design information stored, that has been selected for creator 12, to terminal 100a of creator 12 (S106). Here, the “design information that has been selected for creator 12” may be design information, among the design information stored, that conforms to an attribute of creator 12. The design information may be, for example, information indicating the shape, color, texture, or the like of a three-dimensional object placed in a building, such as interior appliances including furniture, devices (household appliances), household goods, or the like. The design information may also be information indicating the shape, color, texture, or the like of a three-dimensional object expressing a structure, such as a door, an opening, a column, a beam, a wall, or the like in a building, for example. The design information may include information indicating the type of the three-dimensional object indicated by the design information. As described above, the type of the three-dimensional object is an interior appliance such as furniture, a device (a household appliance), a household good, a door, an opening, a column, a beam, a wall, or the like in a building, or the like. The creator ID for identifying creator 12 may be associated with a type of three-dimensional object for which creator 12 is skilled at enhancing the detail. In other words, the attribute of creator 12 may be a type of three-dimensional object for which creator 12 is skilled at enhancing the detail.

Terminal 100a of creator 12 generates detail-enhanced content information based on the design information received from service server 200 (S107). Specifically, terminal 100a accepts an input for detail enhancement from creator 12 via a tool for detail enhancement and, based on the input, enhances the detail of the three-dimensional object indicated by the design information. The detail-enhanced content information is generated as a result. The content information is generated in a first platform based on the design information including the shape of the three-dimensional object in the three-dimensional space. As such, the content information includes information indicating the color, texture, and shape of the three-dimensional object.

Terminal 100a sends detail-enhanced content information and the creator ID for identifying creator 12 that generated the content information to service server 200 (S108). In step S108, the design information ID for identifying the design information based on the detail-enhanced content information may also be transmitted to service server 200. The design information ID may be indicated by the NFT ID of a second NFT corresponding to the design information.

Note that in step S106, a task for enhancing the detail may be generated for each item of design information, and the task may be published to terminal 100a of creator 12, as in a Decentralized Autonomous Organization (DAO). Then, when the published task is selected by creator 12 through terminal 100a, the design information corresponding to the selected task may be sent to terminal 100a of creator 12. A single task may be sent (published) to terminals 100a of a plurality of creators 12. In this case, service server 200 may receive detail-enhanced content information from each terminal 100a of the plurality of creators 12.

The detail enhancement may be performed over a plurality of steps. In other words, one creator 12 may generate content information by enhancing the detail of the design information, and another creator 12 may generate content information by further enhancing the detail of the content information generated by the one creator 12. For example, based on a blueprint as the design information, one creator 12 may generate first content information by enhancing the detail only of a texture, and another creator 12 may generate second content information by performing detail enhancement for adding a lighting or reflection effect to the first content information. In this manner, the detail enhancement may be performed over a plurality of steps by a plurality of creators 12 executing different types of detail enhancement on a single item of design information. In this case, an NFT is issued for each of the design information, the first content information, and the second content information. The NFT to be issued includes a user ID for identifying the user (producer 11 or creator 12) who generated the information corresponding to the NFT (the design information, the first content information, or the second content information), and the NFT ID of the NFT corresponding to the information based on which the stated information was generated.

Note that these plurality of types of detail enhancement may be performed in parallel. In other words, the first content information generated by enhancing the detail of the texture of the design information, and the second content information generated by enhancing the detail by adding a lighting or reflection effect to the same design information, may be generated separately. In this case, third content information integrating the first content information and the second content information may be generated. This third content information is equivalent to second content information generated through detail enhancement that adds a lighting or reflection effect to the first content information for which detail enhancement for only the texture has been performed on the design information. In this case, an NFT is issued for each of the design information, the first content information, and the second content information. The NFT to be issued includes a user ID for identifying the user (producer 11 or creator 12) who generated the information corresponding to the NFT (the design information, the first content information, and the second content information), and the NFT ID of the NFT corresponding to the information based on which the stated information was generated. An NFT is also issued for the third content information. The NFT corresponding to the third content information includes an NFT ID of the NFT corresponding to the design information, an NFT ID of the NFT corresponding to the first content information, and an NFT ID of the NFT corresponding to the second content information.

Service server 200 stores the creator ID, the detail-enhanced content information, and the design information ID in the memory in association with each other (S109).

Service server 200 generates an NFT corresponding to the detail-enhanced content information (S110). The NFT corresponding to the detail-enhanced content information is an example of a first NFT. The NFT corresponding to the detail-enhanced content information may include a creator ID and a design information ID. This NFT is indicated as “NFT 2” in the figures.

Service server 200 sends the detail-enhanced content information to terminal 100b of producer 11 (S111).

Terminal 100b of producer 11 determines whether to list the detail-enhanced content information on experiential commerce service platform 20 (S112). Terminal 100b may make this determination in response to an input indicating whether to list from the user serving as producer 11. If a plurality of items of detail-enhanced content information are generated for a single item of design information by a plurality of creators 12, the user serving as producer 11 may make an input to terminal 100b for selecting (using) one of the plurality of detail-enhanced content information. In step S112, whether to list may be determined based on a score calculated by evaluating the detail-enhanced content information. For example, if the score is higher than a reference value, content information having the score may be determined to be listed. In addition, if one of a plurality of items of the detail-enhanced content information is selected, the content information having the highest score may be selected.

The score may be calculated based on the reliability of creator 12, or may be calculated based on the completeness of the content information. The reliability may be calculated based on the number of items of content information generated by creator 12 that have been listed in the past, or the probability of creator 12 listing content information. The completeness may be calculated based on the percentage of locations for which detail has been enhanced, the rate of increase in the amount of information, or the like, or may be calculated using a learning model employing supervised learning that combines completenesses with detail-enhanced content information in advance.

In addition, the value of the NFT corresponding to the content information to be listed on experiential commerce service platform 20 may be determined based on a difference in the amount of information by comparing the amounts of information in automatically detail-enhanced content information and manually detail-enhanced content information. For example, the value of the NFT may be determined such that the value increases as the stated difference increases.

The content information may also include content that is not associated with a real item. If the real item is a house or a single room, the content not associated with a real item is content that reproduces the surrounding environment of the house or a room, e.g., audio information expressing the singing of birds, the sound of waves, the sound of wind, the sound of flowing water, or the like in the surrounding environment, or information expressing changes caused by sunlight entering the house or a room. The content information indicating the content not associated with a real item may be generated as information from the detail-enhanced content information. In this case, an NFT may be issued for the content information indicating the content not associated with a real item. The NFT may include identification information indicating that the NFT is not associated with a real item.

The content expressed by the content information is a first three-dimensional object in a three-dimensional space. A first space occupied by the first three-dimensional object may include a second space occupied by a second three-dimensional object. For example, the first three-dimensional object may be a building, and the second three-dimensional object may be an object (e.g., an interior item such as furniture, a device (a household appliance), a household good, or the like) present inside the building.

The first space occupied by the first three-dimensional object may also be included in the second space occupied by the second three-dimensional object. For example, the second three-dimensional object may be a building, and the first three-dimensional object may be an object (e.g., an interior item such as furniture, a device (a household appliance), a household good, or the like) present inside the building.

In addition, the content information expressing the first three-dimensional object may include first location information indicating the location of the first three-dimensional object in the three-dimensional space. The content information expressing the second three-dimensional object may include second location information indicating the location of the second three-dimensional object in the three-dimensional space.

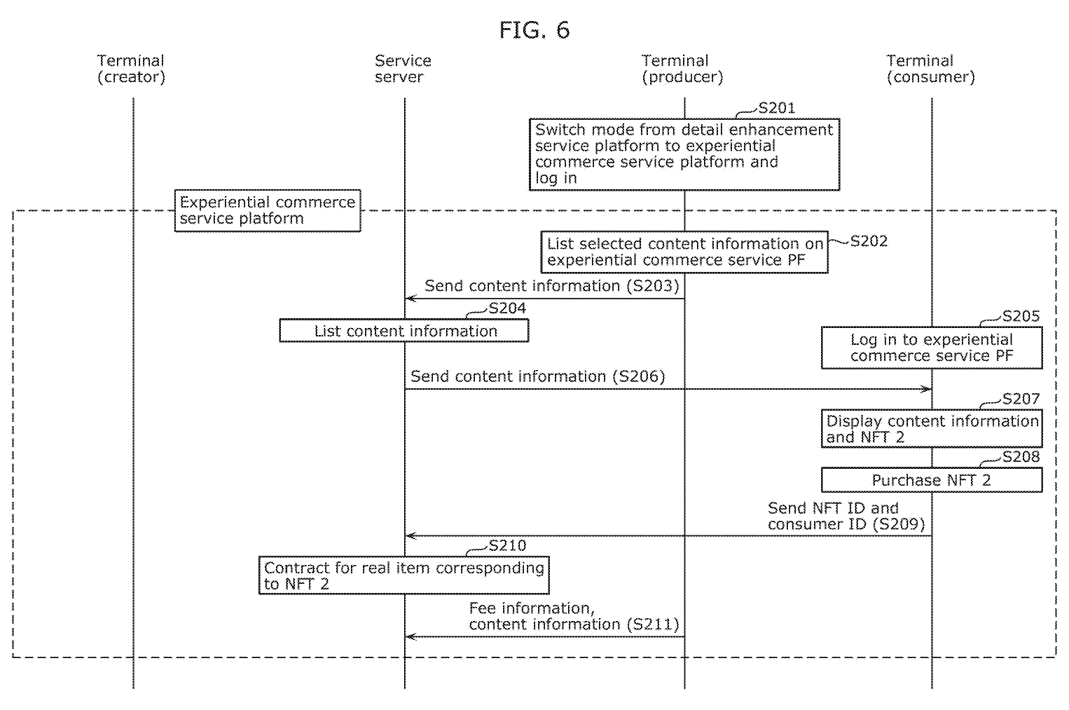

FIG. 6 is a sequence chart illustrating an example of processing for implementing the experiential commerce service platform according to the embodiment.

A user serving as producer 11 logs into experiential commerce service platform 20 by switching modes through terminal 100b (S201). On login, terminal 100b accepts the input of information for logging in to experiential commerce service platform 20 from producer 11 (e.g., the producer ID for identifying producer 11, and a password) and sends that information to service server 200, and then receives information for using experiential commerce service platform 20 from service server 200. Terminal 100b displays a UI based on the information for using experiential commerce service platform 20, accepts an input to the UI from the user serving as producer 11, and changes information to be displayed in response to the received input, stores information generated in response to the input, and the like.

Terminal 100b lists the content information selected in step S112 on experiential commerce service platform 20 (S202).

Terminal 100b sends the content information to be listed to service server 200 (S203).

Upon receiving (obtaining) the content information from terminal 100b, service server 200 stores the received content information as content information to be listed on experiential commerce service platform 20, and lists the content information (S204). As a result, the NFT corresponding to the stored content information is listed in the virtual space on experiential commerce service platform 20.

A plurality of NFTs corresponding to a single item of content information may be listed. The plurality of NFTs may be different NFTs from each other, and each may be associated with a plurality of real items that are the same as each other. The quantity of the plurality of NFTs is the same as the quantity of the plurality of real items. For example, N (where N is a natural number) NFTs corresponding to N desks of the same shape may be issued. The N desks are an example of real items. Each of the N NFTs is an NFT generated based on the content information corresponding to the N desks.

Here, consumer 22 logs into experiential commerce service platform 20 through terminal 100a (S205). On login, terminal 100a accepts the input of information for logging in to experiential commerce service platform 20 from consumer 22 (e.g., a producer ID for identifying consumer 22, and a password) and sends that information to service server 200.

Service server 200 sends the content information to terminal 100a as part of the information for using experiential commerce service platform 20 (S206).

Upon receiving information for using experiential commerce service platform 20 from service server 200 (e.g., VR data), terminal 100a displays an image based on the information for using experiential commerce service platform 20 (S207). The image may include the content information and an NFT corresponding to the content information.

Upon receiving an input from consumer 22 for purchasing the NFT corresponding to the content information, terminal 100a executes processing for purchasing the NFT (S208).

Terminal 100a sends the NFT ID of the purchased NFT and the consumer ID to service server 200 (S209).

Upon receiving the NFT ID and the consumer ID, service server 200 executes processing for entering into a contract for the real item corresponding to the NFT corresponding to the NFT ID (S210). The processing in step S210 includes processing for changing the owner of the real item to consumer 22 who purchased the corresponding NFT, processing for changing the storage location of the real item to a location designated by consumer 22, and the like.

Upon the completion of step S208, terminal 100b of producer 11 sends fee information indicating a fee for establishing a sales contract between producer 11 and consumer 22, and the content information for which the sales contract is established, to service server 200 over experiential commerce service platform 20 (S211). Note that any information for identifying the content information may be sent as the content information sent here, and the content information itself need not be sent.

If the content information is not to be used on a corresponding platform, the content information may be configured to be presented with watermark information indicating that the content information is not to be used on the corresponding platform. For example, when processing based on information for skipping the presentation of the watermark information is not executed, the content information is presented in a state including the watermark information, whereas when processing based on the information for skipping the presentation of the watermark information is executed, the content information is presented in a state not including the watermark information. The corresponding platform may be experiential commerce service platform 20, or may be a predetermined other platform. Whether a platform is a predetermined other platform may be determined based on a digital certificate of the platform. The digital certificate may be implemented by mutual NFTs.

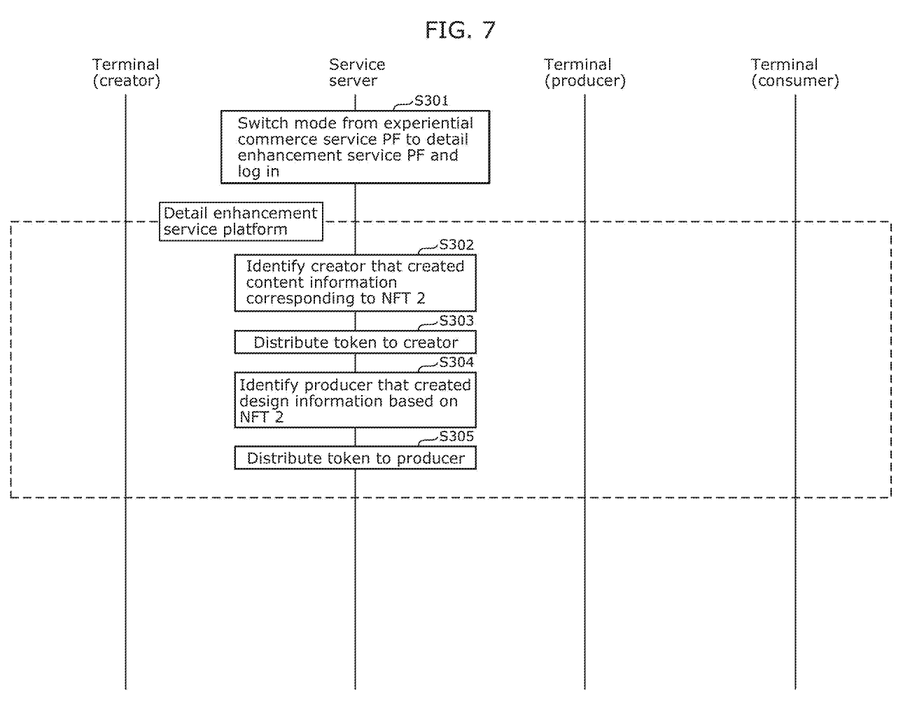

FIG. 7 is a sequence chart illustrating an example of processing for distributing profit according to the embodiment.

Service server 200 switches a mode from experiential commerce service platform 20 to detail enhancement service platform 10 (S301). Note that if service server 200 is providing the two platforms at the same time, step S301 need not be performed.

Service server 200 identifies creator 12 who generated the content information corresponding to the NFT corresponding to the content information, based on that NFT (S302). Specifically, service server 200 identifies creator 12 that generated the content information corresponding to the NFT based on the creator ID included in the NFT.

Service server 200 distributes tokens to creator 12 identified (S303). The tokens to be distributed are calculated based on the fee indicated by the fee information. The fee is an example of a profit based on a token paid in experiential commerce service platform 20. If a plurality of creators 12 are present, the fee is calculated based on a value obtained by dividing the fee by the number of creators 12. In addition, if a plurality of creators 12 are present, the tokens may be distributed so as to be weighted in accordance with a degree of contribution to the detail enhancement of the content information corresponding to the NFT. In other words, the tokens to be distributed may be determined such that more tokens are distributed to creators 12 having higher degrees of contribution. The degree of contribution may be calculated based on a rate of increase in the amount of information in the processing for the detail enhancement. In other words, the degree of contribution by creator 12 may be calculated such that the processing for the detail enhancement increases the degree of contribution for creator 12 who increased the amount of information more.

In addition, the degree of contribution by creator 12 may be calculated by comparing the sales of content information associated with the content not associated with a real item, with the sales of content information not associated with that content, and calculating a higher degree of contribution for creator 12 who generated content information having higher sales. In addition, regardless of whether the content information includes content not associated with a real item, the degree of contribution may be calculated in accordance with the type of the content information, the location of the content information in the virtual space, creator 12 of the content information, and the like.

Service server 200 may identify the user who generated the information on which the NFT is based (S304). Specifically, service server 200 specifies one or more NFTs corresponding to one or more NFT IDs included in the NFT, and identifies the user who generated one or more items of information corresponding to the one or more NFTs included in the specified one or more NFTs. The one or more NFTs are NFTs corresponding to the design information. For example, service server 200 identifies the NFT corresponding to the design information based on the design information ID included in the NFT, and identifies producer 11 based on the producer ID included in the specified NFT. If the content information corresponding to the NFT subject to buying and selling is generated based on a plurality of items of information (e.g., design information and other content information), i.e., if the one or more items of information described above are a plurality of items of information, producer 11 who generated the design information and another creator 12 who generated the other content information are identified.

Service server 200 may further distribute tokens to producer 11 identified (S305). If step S305 is performed, in step S303, not all of the fee is distributed to creator 12, and the remainder is instead distributed to producer 11. If the content information corresponding to the NFT being bought and sold is generated based on a plurality of items of information, service server 200 may further distribute the tokens to the identified producer 11 and other creator 12.

In the token distribution, only the amount of tokens to be distributed may be determined, and the actual token payment to creator 12 or producer 11 may be made at another timing, or at the same timing.

Note that detail enhancement service platform 10 and experiential commerce service platform 20 may be implemented on different blockchains. Transactions in detail enhancement service platform 10 are recorded in a first blockchain, and transactions in experiential commerce service platform 20 are recorded in a second blockchain different from the first blockchain. For example, the NFT corresponding to the design information is recorded in the first blockchain. Meanwhile, the NFT corresponding to the content information to be listed is recorded in the second blockchain, for example.

The transactions in detail enhancement service platform 10 may also be executed by a smart contract stored in the first blockchain. The transactions in experiential commerce service platform 20 may also be executed by a smart contract stored in the second blockchain. For example, producer 11 may pay a fee to operator 13 for establishing a sales contract by executing a smart contract in the second blockchain implements experiential commerce service platform 20, and store transaction data indicating that the fee has been paid in the first blockchain. Through this, processing of distributing tokens based on the fee to creator 12 may be executed by the smart contract stored in the first blockchain.

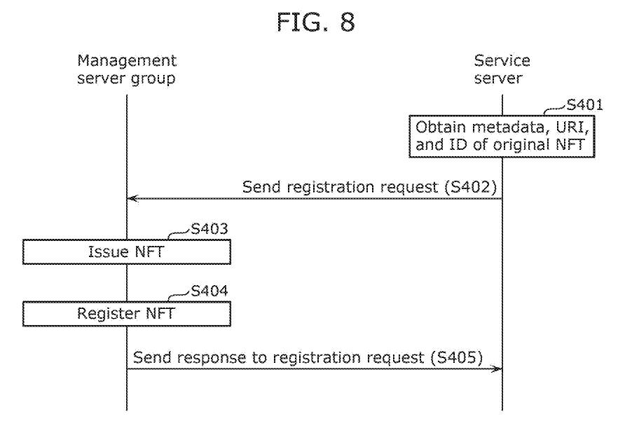

FIG. 8 is a sequence chart illustrating an example of processing for registering an NFT corresponding to content information according to the embodiment.

Service server 200 obtains metadata, a URI, and the ID of the original NFT (the NFT corresponding to the design information, or the NFT corresponding to the first content information generated by the first step of detail enhancement) (S401). The metadata includes content information corresponding to the NFT, for example. The URI indicates an address where the metadata is stored.

Service server 200 sends a registration request for the NFT to management servers 300a to 300c (S402). The registration request includes the NFT ID indicating the original NFT.

Management servers 300a to 300c issue a new NFT by generating a new NFT ID in response to the registration request (S403).

Management servers 300a to 300c register the NFT in the blockchain by storing the issued NFT ID in the distributed ledger (S404).

Management servers 300a to 300c send information indicating that a new NFT has been issued to service server 200 in response to the registration request (S405).

### Effects

In the control method according to the present embodiment, service server 200 (a control device) obtains first content information subjected to detail enhancement in a virtual space, the first content information being generated in detail enhancement service platform 10 (a first platform) that is for performing the detail enhancement on content (S108). Service server 200 lists a first non-fungible token (NFT) associated with the first content information on experiential commerce service platform 20 (a second platform) that is for buying and selling the first NFT (S204). Service server 200 distributes, to creator 12 who generated the first content information in detail enhancement service platform 10, a profit based on a token paid in experiential commerce service platform 20.

Accordingly, profit from the buying and selling of an NFT corresponding to content information can be appropriately distributed to the creator of the content information. In addition, because the processing in the two platforms is executed by the single service server 200, communication fees, the amount of data processed, and the amount of data stored can be reduced.

In the control method according to the present embodiment, the first NFT includes NFT information for identifying a second NFT associated with design information. The distributing includes further distributing the profit to a designer who generated the design information.

Accordingly, profit from the buying and selling of an NFT corresponding to the content information can be appropriately distributed to the designer who generated the design information.

### Supplemental Descriptions

Supplementary descriptions of the distributed ledger used in the foregoing embodiment or variations will be given next. Although a blockchain is described here as an example of a distributed ledger, the same applies to other distributed ledgers as well.

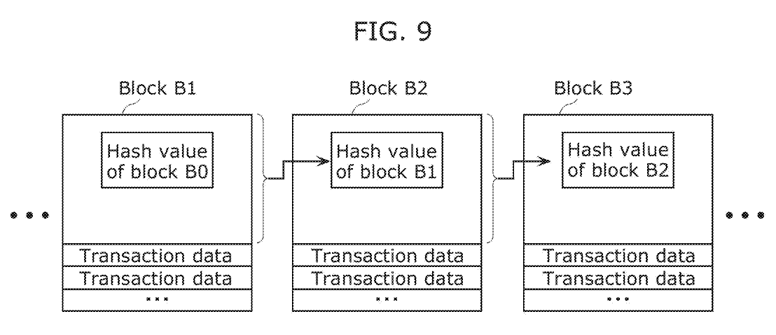

FIG. 9 is an explanatory diagram illustrating the data structure of a blockchain.

A “blockchain” is a connection of blocks, which serve as a unit of record, in the form of a chain. Each block includes a plurality of instances of transaction data and a hash value of the block immediately previous in the chain. Specifically, block B2 includes the hash value of block B1, which is immediately previous in the chain. A hash value computed from the plurality of instances of transaction data included in block B2 and the hash value of block B1 is then included in block B3 as the hash value of block B2. Connecting the blocks in a chain with each block including the details of the previous block as a hash value in this manner makes it possible to effectively prevent tampering with the recorded transaction data.

If, for example, a past instance of transaction data has been changed, the hash value of the block will have a value different from the pre-change value. This means that to make a block which has been tampered with appear normal, it is necessary to rebuild all the blocks previous thereto, which is a task that is extremely difficult in practice. This characteristic is used to ensure that it is difficult to tamper with the blockchain.

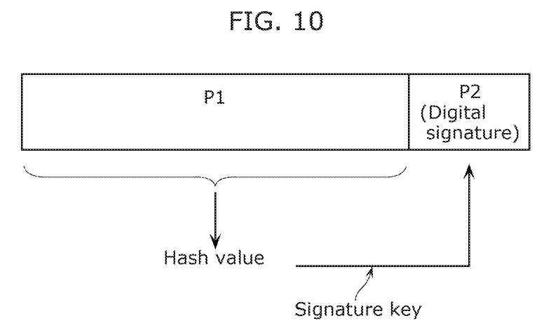

FIG. 10 is an explanatory diagram illustrating the data structure of transaction data.

The transaction data illustrated in FIG. 10 contains main transaction part P1 and digital signature P2. Main transaction part P1 is the main data of that transaction data. Digital signature P2 is a digital signature generated using a signature key of the creator of the transaction data on the hash value of main transaction part P1, and more specifically, is generated by encrypting the hash value using a private key of the creator of the transaction data. The digital signature method is, for example, the Elliptic Curve Digital Signature Algorithm (ECDSA), CRYSTALS-Dilithium, Falcon, SPHINCS+, or the like.

The transaction data has digital signature P2 and is therefore substantially impossible to be tampered with. This is because if the transaction data is tampered with, verification using digital signature P2 will fail, making it clear that the transaction data has been tampered with. This prevents main transaction part P1 itself from being tampered with.

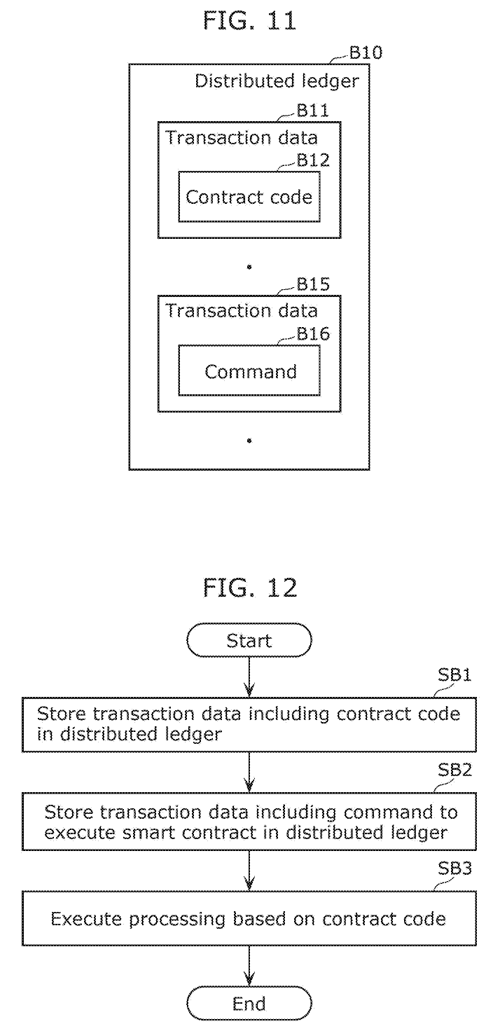

FIG. 11 is an explanatory diagram illustrating transaction data related to the execution of a smart contract. FIG. 12 is an explanatory diagram illustrating processing related to the execution of a smart contract.

A series of processing for executing a smart contract using a distributed ledger will be described with reference to FIGS. 11 and 12.

In step SB1, a node stores transaction data B11, including contract code B12 describing the processing of the smart contract, in distributed ledger B10. For example, the node obtains transaction data B11 by receiving transaction data B11 through communication from an information processing device, or by the node itself generating transaction data B11, and stores transaction data B11 obtained in distributed ledger B10. Step SB1 is performed before executing the smart contract.

In step SB2, the node stores transaction data B15, including command B16 to execute the smart contract, in distributed ledger B10. For example, the node receives transaction data B15 through communication from an information processing device, and stores transaction data B15 received in distributed ledger B10.

In step SB3, the node reads out contract code B12 from distributed ledger B10 in response to transaction data B15, including command B16, being stored in distributed ledger B10 in step SB2, and executes processing based on contract code B12. The result of the processing may be included in the transaction data and stored in distributed ledger B10.

Through the foregoing series of processing, when transaction data B15 including command B16 to execute the smart contract is received, the distributed ledger system automatically (i.e., without requiring work to be performed by a person) executes processing in accordance with command B16, and thus the processing can be executed with a high level of efficiency (i.e., quickly, or in a short period of time). Implementing highly-efficient processing has the effect of reducing power consumption. In addition, because work by a person is not required, situations where a person tampers with the information, acts improperly, or makes a human error can be avoided. Furthermore, the result of the processing executed in this manner is stored in the blockchain, which can make it substantially impossible for the result of the processing to be tampered with.

In the foregoing embodiment and variations, the constituent elements are constituted by dedicated hardware. However, the constituent elements may be realized by executing software programs corresponding to those constituent elements. Each constituent element may be realized by a program executing unit such as a CPU or a processor reading out and executing a software program recorded into a recording medium such as a hard disk or semiconductor memory. Here, the software that realizes the information processing device (i.e., a virtual space management server) and the like according to the foregoing embodiment and variations is a program such as that described below.

In other words, the program is a program that causes a computer to execute an information processing method executed by an information processing device using a processor, the method including: obtaining first content information subjected to detail enhancement in a virtual space, the first content information being generated in a first platform that is for performing the detail enhancement on content; listing a first non-fungible token (NFT) associated with the first content information on a second platform that is for buying and selling the first NFT; and distributing, to a creator who generated the first content information in the first platform, a profit based on a token paid in the second platform.

An information processing device (i.e., a virtual space management server) and the like according to one or more aspects have been described based on an embodiment, but the present disclosure is not limited to this embodiment. Variations on the embodiment conceived by one skilled in the art, embodiments implemented by combining constituent elements from different other embodiments, and the like may be included in the scope of one or more aspects as well, as long as they do not depart from the essential spirit of the present disclosure.

### Industrial Applicability

The present disclosure can be used in an information processing device that generates a virtual space.

1. A control method performed by a control device, the control method comprising:
obtaining first content information subjected to detail enhancement in a virtual space, the first content information being generated in a first platform that is for performing the detail enhancement on content;
listing a first non-fungible token (NFT) associated with the first content information on a second platform that is for buying and selling the first NFT; and
distributing, to a creator who generated the first content information in the first platform, a profit based on a token paid in the second platform.

2. The control method according to claim 1, wherein the first content information is generated in the first platform based on design information including a shape of a first three-dimensional object in a three-dimensional space, and includes information indicating a color, a texture, and a shape of the first three-dimensional object.

3. The control method according to claim 1, wherein the first NFT includes creator information for identifying the creator, and the distributing includes identifying the creator based on the creator information included in the first NFT.

4. The control method according to claim 2, wherein the first NFT includes NFT information for identifying a second NFT associated with the design information, and the distributing includes further distributing the profit to a designer who generated the design information.

5. The control method according to claim 4, wherein the second NFT includes designer information for identifying the designer who generated the design information, and the distributing includes identifying the designer based on the designer information included in the second NFT.

6. The control method according to claim 4, wherein the first NFT is stored in a first blockchain in the first platform, and the second NFT is stored in a second blockchain in the second platform.

7. The control method according to claim 1, wherein content expressed by the first content information is a first three-dimensional object in a three-dimensional space, and a first space occupied by the first three-dimensional object includes a second space occupied by a second three-dimensional object.

8. The control method according to claim 7, wherein the first three-dimensional object is a building, and the second three-dimensional object is an object present within the building.

9. The control method according to claim 1, wherein content expressed by the first content information is a first three-dimensional object in a three-dimensional space, and a first space occupied by the first three-dimensional object is included in a second space occupied by a second three-dimensional object.

10. The control method according to claim 9, wherein the second three-dimensional object is a building, and the first three-dimensional object is an object present within the building.

11. The control method according to claim 7, wherein the first content information includes first location information indicating a location of the first three-dimensional object in the three-dimensional space, and second content information expressing the second three-dimensional object includes second location information indicating a location of the second three-dimensional object in the three-dimensional space.

12. A control device comprising: a processor; and a memory, wherein using the memory, the processor: obtains first content information subjected to detail enhancement in a virtual space, the first content information being generated in a first platform that is for performing the detail enhancement on content; lists a first NFT associated with the first content information on a second platform that is for buying and selling the first NFT; and distributes, to a creator who generated the first content information in the first platform, a profit based on a token paid in the second platform.

13. A non-transitory computer-readable recording medium having recorded thereon a program for causing a computer to execute the control method according to claim 1.
